(19) United States
(12) Patent Application Publication
(10) Pub. No.: US 2023/0055983 A1
(43) Pub. Date: Feb. 23, 2023

(54) LIQUID INTAKE WITH REMOVABLE COVER

(71) Applicant: Quest Integrity Group, LLC, Sugar Land, TX (US)

(72) Inventor: Maarten Cornelis BURGGRAAFF, Tricht (NL)

(21) Appl. No.: 17/775,470

(22) PCT Filed: Nov. 16, 2020
(86) PCT No.: PCT/US20/60646

§ 371 Date: May 9, 2022

Related U.S. Application Data
(60) Provisional application No. 62/936,086, filed on Nov. 15, 2019.

(51) Int. Cl. F04B 53/16; C10G 9/16; F16L 43/00; F16L 55/115; F15D 1/04; F16L 55/46

(52) U.S. Cl. CPC F04B 53/16; C10G 9/16; F16L 43/001; F16L 55/115; F15D 1/04; F16L 55/46

(57) ABSTRACT

Devices and methods to impart liquid into a pumping unit are described herein. Specifically, a vertical liquid intake is described which allows for diversion of liquid flow from horizontal to vertical without a loss of capacity or increased risk of cavitation. The liquid intake generally includes a body with separate channels and a removable cover.

### CROSS-REFERENCE TO RELATED APPLICATIONS

This application claims priority to U.S. Provisional Patent Application Ser. No. 62/936,086, filed Nov. 15, 2019, entitled “Liquid Intake Manifold with Removable Cover,” which is incorporated herein by reference.

### FIELD

This application relates to a liquid intake, specifically, a liquid intake with a removable cover for use within a decoking apparatus.

### BACKGROUND

Petrochemical plants and refineries utilize fired heaters that are exposed to harsh chemicals that can create scale and coke in the heater tubes. This buildup of materials can lead to inefficiencies in the plants and refineries such as reduced process output, higher costs, greater environmental harm and pollutants, and a reduced life of the heater tubes. To avoid these inefficiencies and maintain peak efficiency of the plants and refineries, the heater tubes require regular cleaning and monitoring. One method of doing so is mechanical decoking.

Mechanical decoking is the process of passing a device called a pig through tubing or pipelines for cleaning and inspection purposes. The pig is passed through the tubing or pipeline by fluid pressure. This fluid pressure is achieved with a fluid circuit comprising a launcher and a receiver attached at opposite ends of the tubing and an external pigging unit to create and control the fluid pressure within the system.

A liquid intake is typically used to feed clean fluid, such as water, into the circuit and facilitate the necessary fluid pressure to feed the pig through the tubing. Generally, liquid intakes for decoking purposes have a horizontal connection. However, there are certain benefits to a vertical connection, including but not limited to less space needed for the system to function. This additional space created by a liquid intake allows two pumps to be mounted next to each other within a single container, an option not readily available with a standard horizontal connection. In this way, a vertical liquid intake can be advantageous for plants and locations with space or weight restrictions.

Proper configuration of a liquid intake is challenging, and frequently results in performance and reliability issues. The layout of the intake and the relative positioning of the pumps are important to the reliability, performance, and operation of a decoking system. A poor intake can result in not only operational problems, but also capacity and efficiency losses and even damages due to vibration and cavitation. To help alleviate these potential issues, the entirety of the flow paths within the intake should be considered and managed, and vortices due to flow separation in the approaching liquid should be prevented. To ensure the liquid intake can function efficiently, there is a need to easily access the internal channels, or flow path, of a liquid intake manifold to remove any debris or obstructions that may block the flow of liquid within the fluid pressure system.

For previous liquid intakes, shifting the incoming fluid flow from horizontal to vertical or vice versa has been a challenge without risking efficiency, capacity, or creating dangerous conditions. Some attempted solutions have tried to create a vertical liquid intake with distinct channels or flow paths, but this has not sufficiently addressed the needs of the industry owing to its need for heavy welding at plate junctions. The welding process can change the shape and interior finish of the intake and thus increase the risk of cavitation. Cavitation is the formation of bubbles in liquid due to a pressure drop in the flowing liquid. When these bubbles move through the pump system, they can implode. This implosion can result in erosion to the pump housing and potentially pump failure.

Therefore, a need exists for a reliable vertical connection liquid intake that can be manufactured and utilized without increased risk of cavitation or significantly changing the shape and finish of the liquid intake manifold during manufacture. Allowing the increased efficiency and space-saving benefits of the vertical connection liquid intake without the usual risks.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

Devices and methods for a liquid intake are described herein. Embodiments may include a body with at least one channel; a plurality of openings capable of introducing fluid flow into the body; and a removable cover positioned over at least one access hole at an angle to allow for redirection of incoming fluid flow.

One or more embodiments may include the device of the preceding paragraph, wherein the removable cover comprises at least one rigid indentation that complements the at least one access hole.

One or more embodiments may include the device of any preceding paragraph wherein the body has two distinct channels, each channel having a first opening, a second opening, and an access hole.

One or more embodiments may include the device of any preceding paragraph, wherein the two directions are perpendicular to one another.

One or more embodiments may include the device of any preceding paragraph, wherein the two directions have at least one acute angle of intersection.

One or more embodiments may include the device of any preceding paragraph, wherein the removable cover is attached to the body with at least one mechanical fastener.

Embodiments may also include a body with a first planar surface; a second planar surface perpendicular to the first planar surface; an angled planar surface; and a plurality of channels, each channel connecting an opening on the first planar surface to an opening on the second planar surface.

One or more embodiments may include the device of any preceding paragraph, further comprising a removable cover capable of attachment to the angled planar surface.

One or more embodiments may include the device of any preceding paragraph, wherein the removable cover is attached to the angled planar surface with at least one mechanical fastener.

Methods of removing obstructions and debris from a liquid intake are also described herein. Embodiments may include installing the vertical liquid intake with at least one channel, a removable cover, and at least one access hole in a pumping unit; detaching the removable cover from the liquid intake to access and inspect the at least one channel through the access hole; removing obstructions and debris from the channel; and reattaching the removable cover to the liquid intake.

One or more embodiments may include the method of any preceding paragraph, wherein the at least one channel has a first opening positioned in a first direction and second opening positioned in a second direction.

One or more embodiments may include the method of any preceding paragraph, wherein the removable cover is attached to the liquid intake by a plurality of mechanical fasteners.

### BRIEF DESCRIPTION OF DRAWINGS

Certain embodiments of the disclosure will hereafter be described with reference to the accompanying drawings, wherein like reference numerals denote like elements. It is emphasized that, in accordance with standard practices in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein.

FIG. 1A illustrates a top perspective view of an embodiment of the present disclosure showing access holes without the removable cover attached.

FIG. 1B illustrates a bottom perspective view of an embodiment of the present disclosure showing two sets of openings.

FIG. 2A illustrates a top perspective view of an embodiment of the removable cover of the present disclosure.

FIG. 2B illustrates a perspective view of an embodiment of the removable cover of the present disclosure.

FIG. 3 illustrates a top perspective view of an embodiment of the present disclosure with the removable cover attached.

FIG. 4 illustrates a top perspective view of an embodiment of the present disclosure connected to a pumping unit.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions, or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

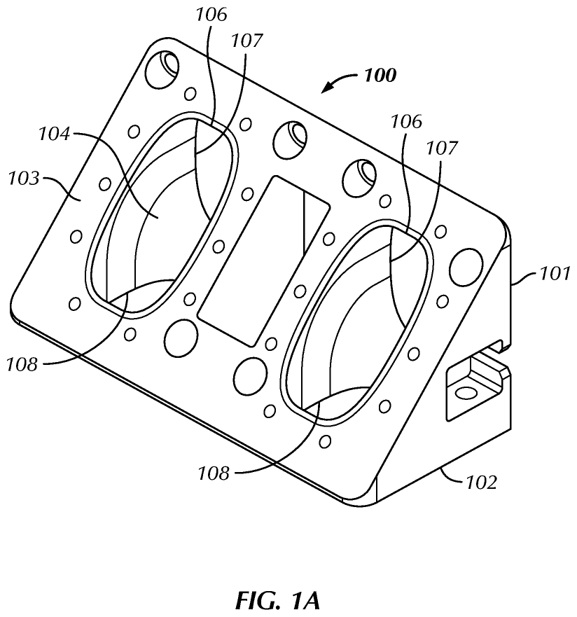

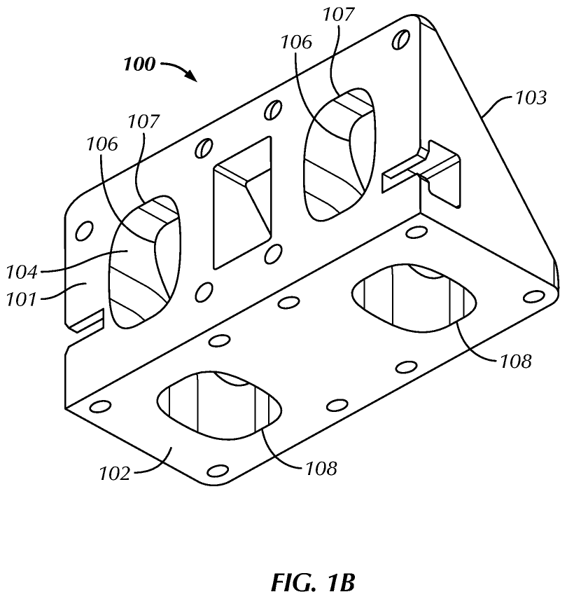

FIG. 1A illustrates a top perspective view of an embodiment of the present disclosure showing access holes 106 without the removable cover (not presently shown) attached. The body 100 has three planar surfaces: a first planar surface 101, a second planar surface 102, and an angled planar surface 103. The entirety of the first planar surface 101 and second planar surface 102 are better demonstrated in FIG. 1B. In certain embodiments, the first planar surface 101 and second planar surface 102 are perpendicular to one another.

Within the body are two separate channels 104, which are hollow to allow for a liquid to pass through the body 100. It will be understood that for purposes of this disclosure, the term channel throughout refers to the passageway or fluid pathway for the flow of fluid. From this angle, the openings 107 of the first planar surface 101 are visible from within the channels 104 by way of the access holes 106. The openings 108 of the second planar surface 102 are also visible. However, these openings (107, 108) are more clearly demonstrated in FIG. 1B.

In embodiments of the present disclosure, the body 100 may be made from a single block, thus negating the requirement for welding during the manufacturing or installation process. The body 100 is stress free with no changes in shape or size that heavy welding can sometimes cause. This offers a significant improvement because fluid can be diverted from a horizontal to vertical direction, and vice versa, by way of the two channels, but there is no need for heavy welding at the plate junction to install these channels. Rather, the body 100 has the channels 104 formed within it, reducing the risk of cavitation and loss of capacity that heavy welding can cause.

When the removable cover (not presently shown) is in place, incoming fluid flow enters the body 100 through one of the openings (107, 108). The openings (107, 108) are positioned in different directions. In certain embodiments, the openings (107, 108) are positioned in directions that are substantially perpendicular. For example, a straight line perpendicular with the diameter of the opening 107 would intersect with a straight line perpendicular with the diameter of the opening 108 at a 90-degree angle of intersection.

In certain other embodiments, the openings (107, 108) are positioned in directions that will intersect at an acute angle of intersection. For purposes of the present disclosure, two straight lines that are not perpendicular to one another but do intersect at a point are defined as having at least one acute angle of intersection. For example, a straight line perpendicular with the diameter of the opening 107 could intersect with a straight line perpendicular with the diameter of the opening 108 at a 60-degree angle of intersection.

This diversion of fluid flow, such as water, occurs without loss of capacity or risk of cavitation due to the shape and finishing of the body 100. The ability of the body 100 to divert fluid flow from a horizontal position to a vertical position yields a liquid intake that requires less space and allows for the mounting of two pumps next to each other in a single container to increase efficiency of the decoking process.

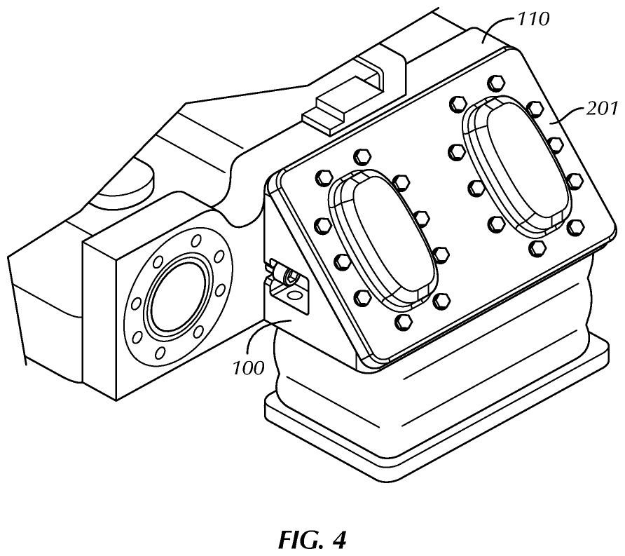

FIG. 1B illustrates a bottom perspective view of an embodiment of the present disclosure showing two sets of openings (107, 108). It should be understood however, that the present disclosure is not so limited as the body may have any number of openings and channels depending on the size and configuration. These openings (107, 108) are attached to a pumping unit that pumps liquid through the channels 104 of the body 100. As shown in greater detail in FIG. 4, the first planar surface 101 joins with a complementary surface within the decoking apparatus. Likewise, the second planar surface 102 joins with a complementary surface within the decoking apparatus. When the first planar surface 101 and second planar surface 102 are engaged with the complementary surfaces, fluid may flow freely through the decoking apparatus in either direction. For example, the first planar surface 101 could be connected to a water reservoir and the second planar surface could be attached to a vertical pumping unit. Water may flow into the liquid intake in a vertical direction from the water reservoir to the pumping unit by way of the openings (107, 108) and through the channels 104. Water may flow through a channel 104 from opening 107 to opening 108, or from opening 108 to opening 107, depending on the particular application.

The access holes 106 may be seen within the channels 104 of this FIG. 1B to further demonstrate the hollow nature of the channels 104 and the general relation of the openings (107, 108) to the access holes 106 within the body 100. The access holes 106 allow for users to inspect the liquid intake and decoking apparatus and, if necessary, remove any debris or obstructions, by detaching the removable cover 201 from the angled planar surface 103.

In embodiments of the present disclosure, the channels 104 are separate and distinct from one another. Liquid in one channel will not interact with liquid in another channel within the body 100. This allows a user to mount two pumps within the same container without using too much valuable space. However, in other embodiments, there may be a need for the channels 104 to form a unitary cavity within the body 100.

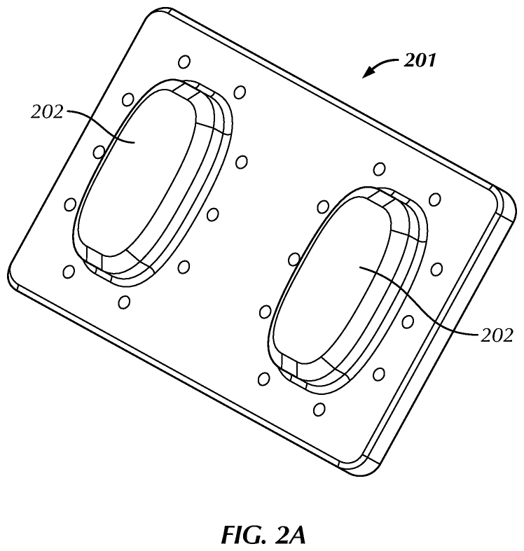

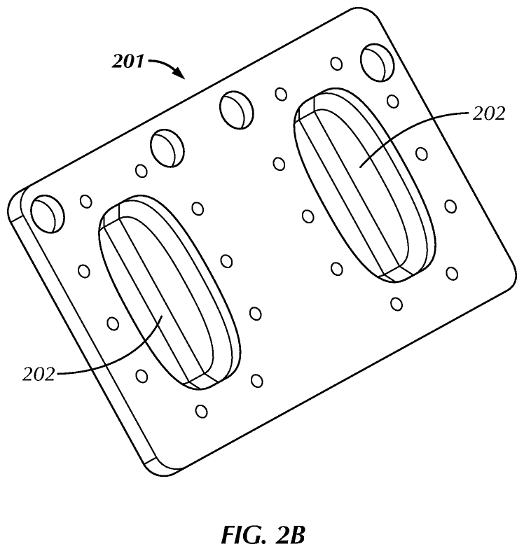

FIG. 2A illustrates a top perspective view of an embodiment of the removable cover 201 of the present disclosure. The removable cover has rigid indentations 202 that are slightly raised from the rest of the removable cover 201 from this perspective. The rigid indentations may help reduce the risk of cavitation, vortices, or other potential issues when the fluid flow is diverted from a first direction to a second direction in a hydraulic system. In certain other embodiments, these rigid indentations 202 could be flush with the rest of the removable cover 201.

FIG. 2B illustrates another perspective view of an embodiment of the removable cover 201 of the present disclosure. This view shows the portion of the removable cover 201 that attaches to the angled planar surface 103 of the body 100. In certain embodiments, the removable cover may be attached to the angled planar surface with at least one mechanical fastener. In certain other embodiments, this may require multiple mechanical fasteners.

This represents just one embodiment of the removable cover 201. The removable cover 201 may also be entirely flat with no rigid indentations 202. In other embodiments, the rigid indentations 202 could face inward. Each removable cover 201 has holes that allow for attachment of the cover 201 to the angled planar surface 103 of the body 100. While the removable cover 201 allows for attachment through a number of bolts, still other methods of attachment are also contemplated and possible so long as they may withstand the pressure of the system.

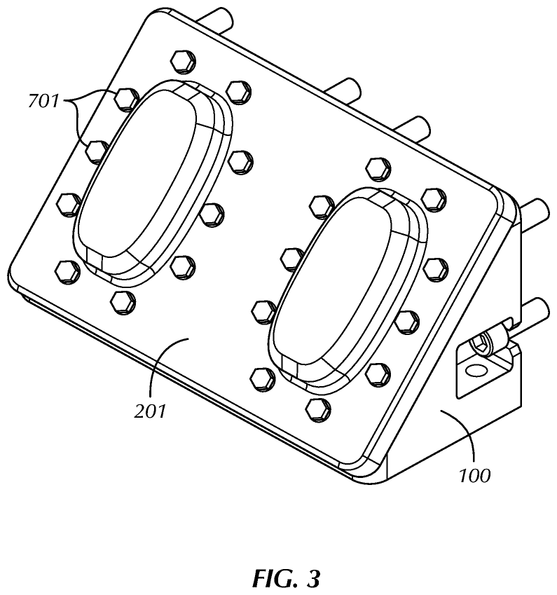

FIG. 3 illustrates a top perspective view of an embodiment of the present disclosure with the removable cover 201 attached. The removable cover 201 is secured to the angled planar surface 103 with multiple mechanical fasteners 701. The rigid indentations 202 are positioned over the access holes 106. The removable cover 201 may be removed to allow inspection of the intake and decoking apparatus for any obstructions or debris, without the need to remove the intake entirely. This offers a significant improvement as the channels 104 within the body 100 are not inaccessible due to heavy welding at plate junctions, thus giving a user an easier access point to address issues that may arise. In some embodiments, they removable cover 201 may include sight glass to allow for easy inspection of the access holes 106 without the necessity to remove the cover 201.

The mechanical fasteners 701 utilized to attach the removable cover 201 can vary depending on the particular needs of a job site. For example, non-permanent mechanical fasteners may be used so as to allow for reattachment of the removable cover 201 with the same mechanical fasteners. However, a permanent mechanical fastener, such as a rivet where the mechanical fastener may only be used once, may also be used to attach the removable cover 201 initially and then replaced with new mechanical fasteners after each time the removable cover 201 needs to be removed.

FIG. 4 illustrates a top perspective view of an embodiment of the present disclosure connected to a pumping unit 110. When the pumping unit 110 is functioning, fluid can pass through the liquid intake by way of the channels 104. The fluid enters the liquid intake in one direction, then leaves in a different direction. For example, in the liquid intake shown in FIG. 4, the fluid could enter the liquid intake in a horizontal direction. Then once it meets resistance from the rigid indentations 202 of the removable cover 201, the fluid is diverted to a vertical direction. In some instances, these two directions could be perpendicular to one another. In other embodiments, the directions could intersect at an angle that is less than 90 degrees, depending on the particular goals of the application.

The liquid intake may be manufactured from carbon steel, stainless steel, a combination of these materials, or any other metal that can withstand the pressure and corrosive chemicals involved in decoking processes. The liquid intake may be of the same material as the surrounding pumping unit or of a different material. The surfaces of the liquid intake may be further treated to resist corrosive chemicals.

While various devices and methods have been described above in connection with several illustrative embodiments, it is to be understood that other similar embodiments may be used or modified, and additions may be made to the described embodiments for performing the same function disclosed herein without deviating therefrom. For example, the present disclosure may have only one channel rather than multiple channels, depending on the capacity of the decoking container and the number of pumps needed for a job site. Further, the present disclosure may be utilized in analogous applications outside of decoking that require vertical pumping units and a diversion of fluid flow from a horizontal to vertical direction, or vice versa.

Further, all embodiments disclosed are not necessarily in the alternative, as various embodiments may be combined or subtracted to provide the desired characteristics. Variations can be made by one having ordinary skill in the art without departing from the spirit and scope hereof. The scope of the present disclosure is determined by the claims that follow.

What is claimed is:

1. A liquid intake comprising:
a body with at least one channel;
a plurality of openings capable of introducing fluid flow into the body in at least two directions; and
a removable cover positioned over at least one access hole at an angle to allow for redirection of incoming fluid flow.

2. The liquid intake of claim 1, wherein the removable cover comprises at least one rigid indentation that complements the at least one access hole.

3. The liquid intake of claim 1, wherein the body has two distinct channels, each channel having a first opening, a second opening, and at least one access hole.

4. The liquid intake of claim 1, wherein the two directions are perpendicular to one another.

5. The liquid intake of claim 1, wherein the two directions intersect at an acute angle of intersection.

6. The liquid intake of claim 1, wherein the removable cover is attached to the body with at least one mechanical fastener.

7. A body of a liquid intake for a decoking apparatus comprising:
a first planar surface;
a second planar surface perpendicular to the first planar surface;
an angled planar surface; and
a plurality of channels, each channel connecting an opening on the first planar surface, an opening on the second planar surface, and an access hole on the angled planar surface.

8. The body of claim 7, further comprising a removable cover capable of attachment to the angled planar surface.

9. The body of claim 7, wherein the removable cover is attached to the angled planar surface with at least one mechanical fastener.

10. A method of removing obstructions and debris from a vertical liquid intake for a decoking apparatus comprising:
installing the vertical liquid intake with at least one channel, a removable cover, and at least one access hole in a pumping unit;
detaching the removable cover from the liquid intake to access and inspect the at least one channel through the access hole;
removing obstructions and debris from the channel; and
reattaching the removable cover to the liquid intake.

11. The method of claim 10, wherein the at least one channel has a first opening positioned in a first direction and a second opening positioned in a second direction.

12. The method of claim 10, wherein the removable cover is attached to the liquid intake by a plurality of mechanical fasteners.
